(19) United States
(12) Patent Application Publication
(10) Pub. No.: US 2013/0241199 A1
(43) Pub. Date: Sep. 19, 2013

(54) DEVICE AND METHOD FOR CENTERING TUBULAR MEMBERS

(71) Applicant: Vincent Bussio, Orem, UT (US)

(72) Inventor: Vincent Bussio, Orem, UT (US)

(21) Appl. No.: 13/676,088

(22) Filed: Nov. 13, 2012

Related U.S. Application Data
(63) Continuation of application No. 13/539,282, filed on Jun. 29, 2012, now abandoned.
Application No. 13/539,282 is a continuation of application No. 13/372,482, filed on Feb. 13, 2012, now abandoned.
Application No. 13/372,482 is a continuation of application No. 13/245,824, filed on Sep. 26, 2011, now abandoned.
(60) Provisional application No. 61/386,438, filed on Sep. 24, 2010.

(51) Int. Cl. F16L 49/02

(52) U.S. Cl. CPC F16L 49/02
USPC 285/399

(57) ABSTRACT

A centering device between two adjacent tubular members, such as pre-cast concrete structures used in a manhole assembly, may comprise a guide member having a sidewall and a crosspiece member. The guide member may be installed on an end of a first tubular member. The second tubular member may be stacked on top of the first tubular member. The guide member may center the first and second tubular members and may prevent horizontal displacement of the first tubular member with respect to the second tubular member.

### CROSS-REFERENCE TO RELATED APPLICATIONS

This application is a continuation of U.S. patent application Ser. No. 13/539,282, filed Jun. 29, 2012, which is a continuation of U.S. patent application Ser. No. 13/372,482, filed Feb. 13, 2012, which is a continuation of U.S. patent application Ser. No. 13/245,824, filed Sep. 26, 2011, which claimed the benefit of U.S. Provisional Application No. 61/386,438, filed Sep. 24, 2010, which are hereby incorporated by reference herein in their entireties, including but not limited to those portions that specifically appear hereinafter, the incorporation by reference being made with the following exception: In the event that any portion of the above-referenced applications is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Present Disclosure

The present disclosure relates generally to devices and methods for centering tubular members of thin-wall design.

2. Description of Related Art

Components of wastewater systems in the U.S. may be formed from pre-cast concrete structures made from cement and aggregate. For example, pre-cast concrete structures may include concrete pipes, box culverts, vaults, catch basins, and manhole assemblies. These pre-cast concrete structures may be formed off site and transported to a work site as needed. At the work site, the pre-cast concrete structures may be installed into wastewater systems, including sewage systems, as is known to one having ordinary skill in the art. Typically, the pre-cast concrete structures may be installed underground.

Traditional pre-cast concrete structures may be interconnected using tongue and groove type joints. For example, referring now to FIG. 1, there is depicted a manhole assembly 1. The manhole assembly 1 may comprise a base section 2, a riser section 3, a cone section 4, a ring section 5, a frame 6, and a cover 7. The base section 2, the riser section 3, and the cone section 4 may be formed from concrete, i.e., a mixture of cement and aggregate.

The base section 2 and the riser section 3 may be joined together using a tongue and groove type joint. In particular, the base section 2 may comprise an annularly shaped tongue 2a. The tongue 2a may slidably engage an annular groove or recess 3a formed in a lower portion of the riser section 3. Likewise, the riser section 3 and the cone section 4 may be joined by a tongue and groove type joint.

Increasingly, pre-cast structures for use in wastewater systems, including sewage systems, are formed using a polymer concrete. As used herein, the term “polymer concrete” may refer to a concrete made from a polymer binder and an aggregate, e.g., a sand and gravel mixture. The wall thickness of pre-cast polymer concrete structures may be thinner than that of structures made using traditional cement. As a result, pre-cast polymer concrete structures are not amenable to the use of tongue and groove type joints. Therefore, there exists a need of an apparatus and method for forming a joint between adjacent pre-cast polymer concrete structures in sewage systems.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is an exploded view of a prior art manhole assembly formed from pre-cast concrete structures using a tongue and groove type joint;

FIG. 2 is a perspective view of a guide member for centering stacked tubular members pursuant to an embodiment of the present disclosure;

FIG. 3 is a bottom view of the guide member depicted in FIG. 2;

FIG. 4 is a top view of the guide member depicted in FIG. 2;

FIG. 5 is a cross-sectional view of the guide member depicted in FIG. 1;

FIG. 6 is a perspective, exploded view of the guide member depicted in FIG. 1 and stacked tubular structures;

FIG. 7 is a cross-sectional view of the guide member depicted in FIG. 1 and stacked tubular structures;

FIG. 8 is a fragmentary view of a manhole assembly incorporating a pair of guide members according to the present disclosure;

FIG. 9 is a cross-sectional view of a guide member according to an embodiment of the present disclosure; and

FIG. 10 is a cross-sectional view of a guide member according to an embodiment of the present disclosure.

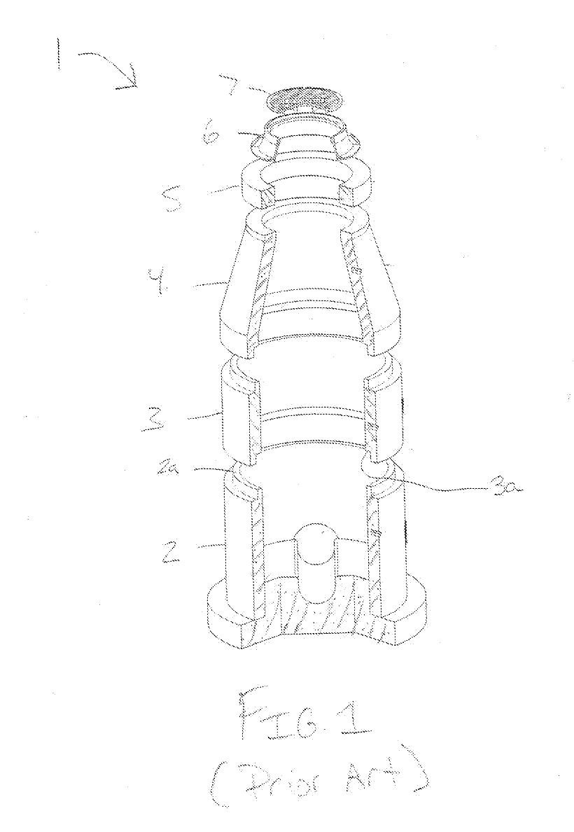

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. It must be noted that, as used in this specification and the appended claims, the singular forms “a,” “an,” and “the” include plural referents unless the context clearly dictates otherwise. As used herein, the terms “comprising,” “including,” “containing,” “characterized by,” “having,” and grammatical equivalents thereof are inclusive or open-ended terms that do not exclude additional, unrecited elements or method steps.

Applicant has discovered a device and method for centering tubular members, such as pre-cast concrete structures used in manhole assemblies, and for forming joints between tubular members. The present disclosure may eliminate the need for traditional tongue and groove joints between adjacent pre-cast concrete structures. The present disclosure may be suited for use with thin-walled pre-cast concrete structures. The present disclosure may be suited for use with pre-cast concrete structures formed from a polymer concrete. The present disclosure may align and center adjacent pre-cast concrete structures during installation.

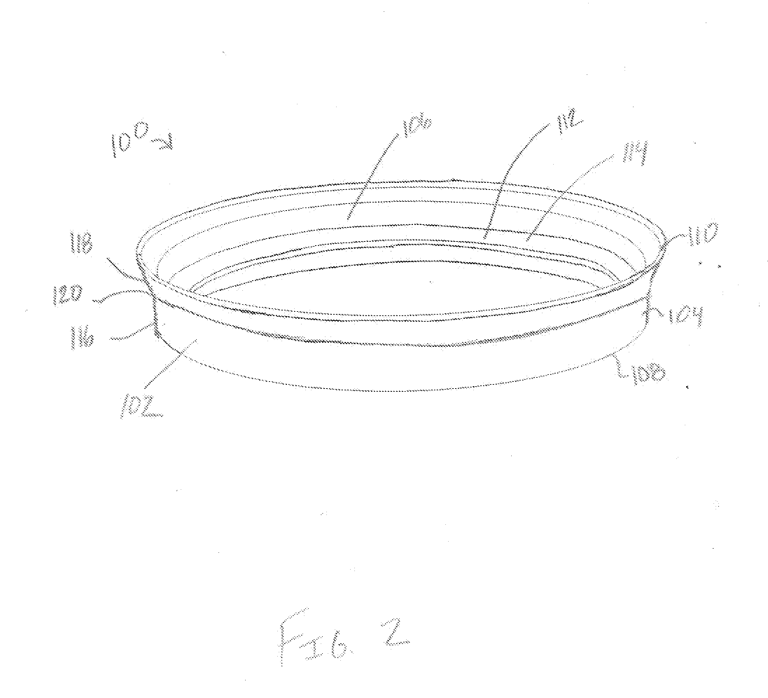

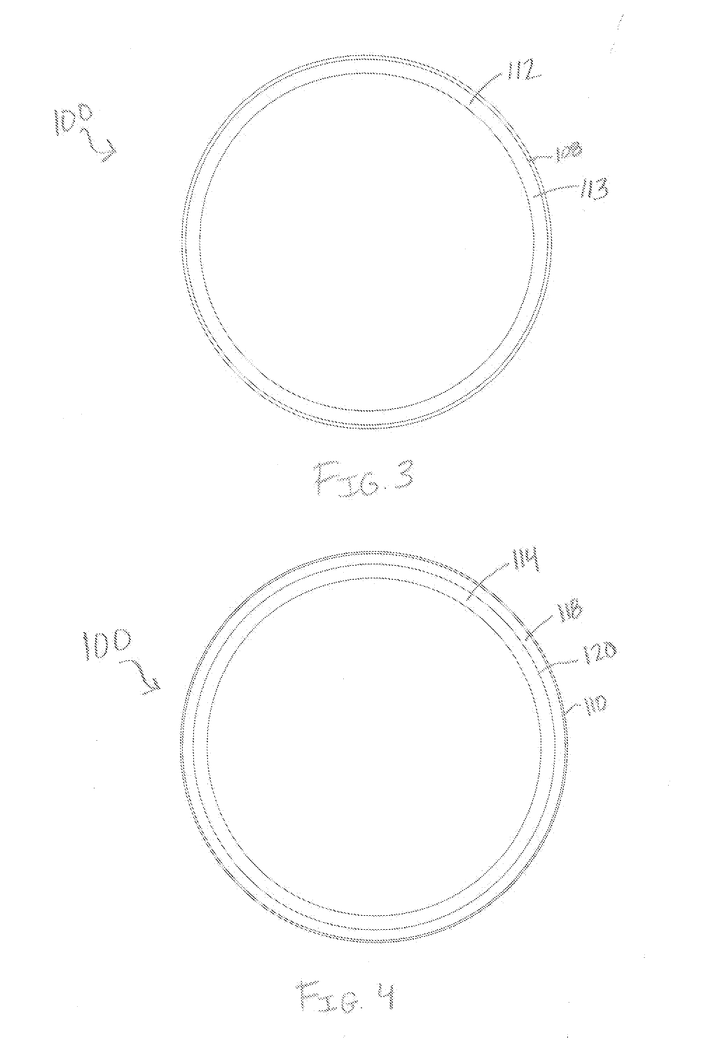

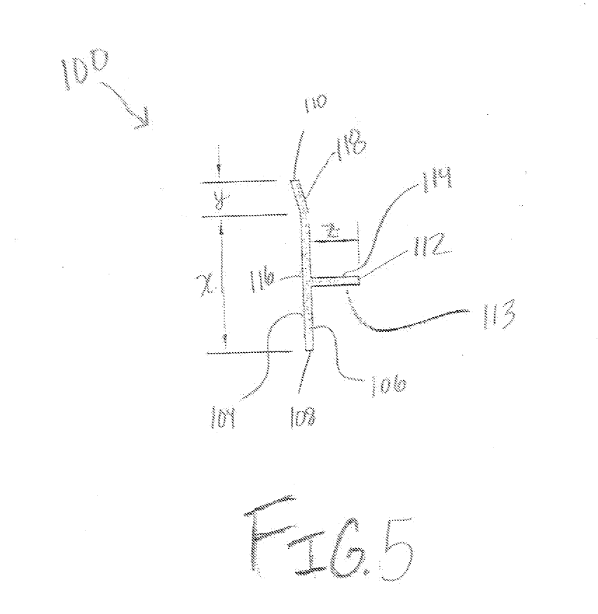

Referring now to FIGS. 2, 3, 4 and 5, there is depicted a guide member 100 according to an embodiment of the present disclosure. The guide member 100 may include a sidewall member 102. The sidewall member 102 may be ring shaped. The sidewall member 102 may have an outer surface 104 and an inner surface 106. A bottom surface 108 may extend between the outer surface 104 and the inner surface 106 to thereby form a lowermost portion of the guide member 100.

A top surface 110 may extend between the outer surface 104 and the inner surface 106 to thereby form a topmost portion of the guide member 100. A cross-piece 112 may extend inwardly from the inner surface 106 of the guide member 100. The cross-piece member 112 may include a bottom surface 113 and a top surface 114. The cross-piece member 112 may be perpendicular to the inner surface 106 of the guide member 100. The cross-piece member 112 may be cantilevered. The sidewall member 102 may include a ring portion 116 and a flared or sloped portion 118. The ring portion 116 may extend between the bottom surface 108 to a transition 120 between the ring portion 116 and the sloped portion 118. The sloped portion 118 may extend between the transition 120 and the top surface 110. The radiuses of the outer surface 104 and the inner surface 106 may be constant along the ring portion 116 of the sidewall member 102. The radiuses of the outer surface 104 and the inner surface 106 may increase along the sloped portion 118 of the annular member 102 from the transition 120 to the top surface 110.

Referring now to FIG. 5, there is depicted a cross-sectional view of the guide member 100 where like reference numerals depict like components. The ring portion 116 may have a height x of between about 3 inches to about 7 inches. In an embodiment of the present disclosure, the height x may be about 4 inches. The sloped portion may have a height y of about 1 inch to about 3 inches. In an embodiment, the height y may be about 1 inch.

In an embodiment of the present disclosure, the cross-piece member 112 may have length z of about the same thickness of a wall of a tubular member onto which the guide member 100 is installed. In an embodiment of the present disclosure, the length z of the cross-piece member 112 may be about 1 to 3 inches. In an embodiment of the length z of the cross-piece member 112 is about 1 and inches.

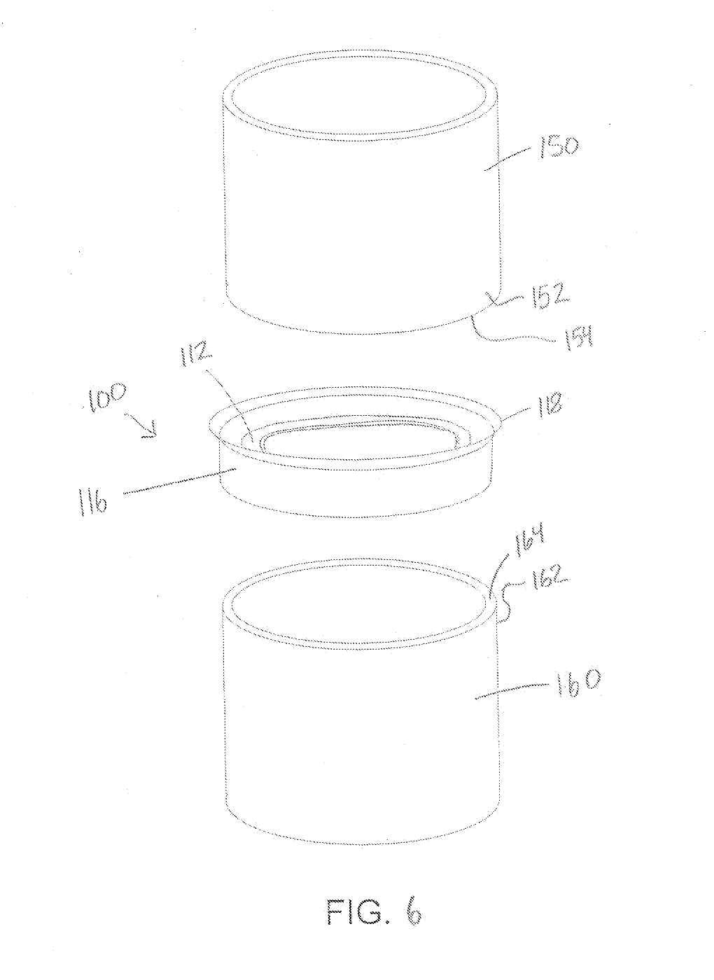

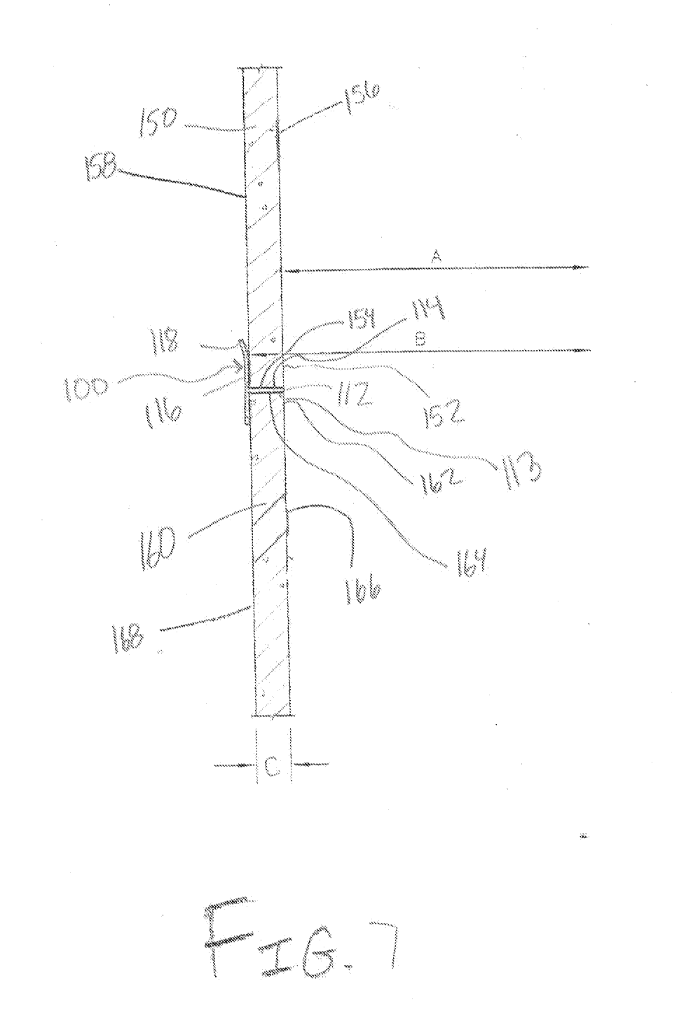

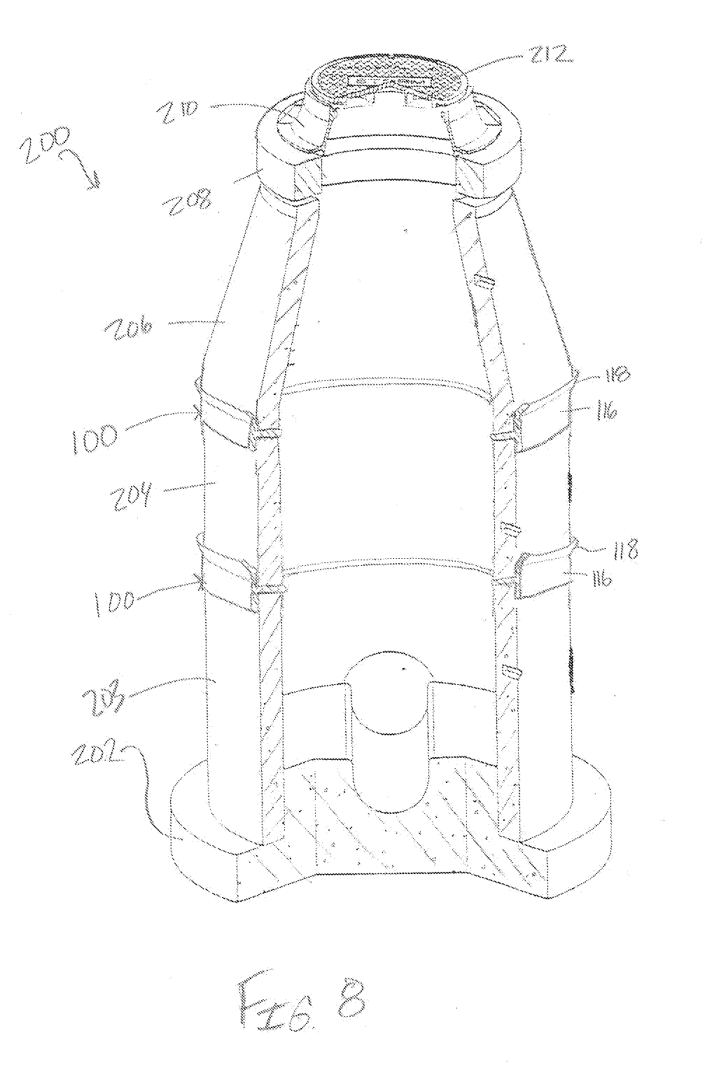

Referring now to FIGS. 6 and 7, there is depicted the guide member 100 in relation to a first tubular member 150 and a second tubular member 160 where like reference numerals depict like components. To center and join the first tubular member 150 and the second tubular member 160, the guide member 100 is first installed onto a top portion 162 of the second tubular member 160. A top surface 164 of the top portion 162 may abut against the lower surface 113 of the cross-piece member 112. Then, a bottom portion 152 of the first tubular member 150 is installed into the guide member 100 such that a bottom surface 154 of the first tubular member 150 abuts against the top surface 114 of the cross-piece member 112. The sloped portion 118 may assist in guiding and centering the lower portion 152 of the first tubular member 150 into the second tubular member 160. The inner wall 106 of the guide member 100 may further center and guide the first tubular member 150 onto the second tubular member 160.

Referring now to FIG. 7, in an embodiment of the present disclosure, an inner wall 156 of the first tubular member 150 and an inner wall 166 of the second tubular member 160 may have a diameter A of about 1 to 10 feet. An outer wall 158 of the first tubular member and an outer wall 168 of the second tubular member 160 may have a diameter B of about 1 to 6 inches greater than the diameter A. A thickness C between the inner wall 156 and the outer wall 158 of the first tubular member 150 may about 1 to 6 inches. An inner diameter of the inner surface of the ring portion 116 may be equal or be about equal to the diameter B such that the guide member 100 may snugly engage, center, and join the first tubular member 150 and the second tubular member 160. In an embodiment of the present disclosure, the first tubular member 150 and the second tubular member 160 may be formed from polymer concrete.

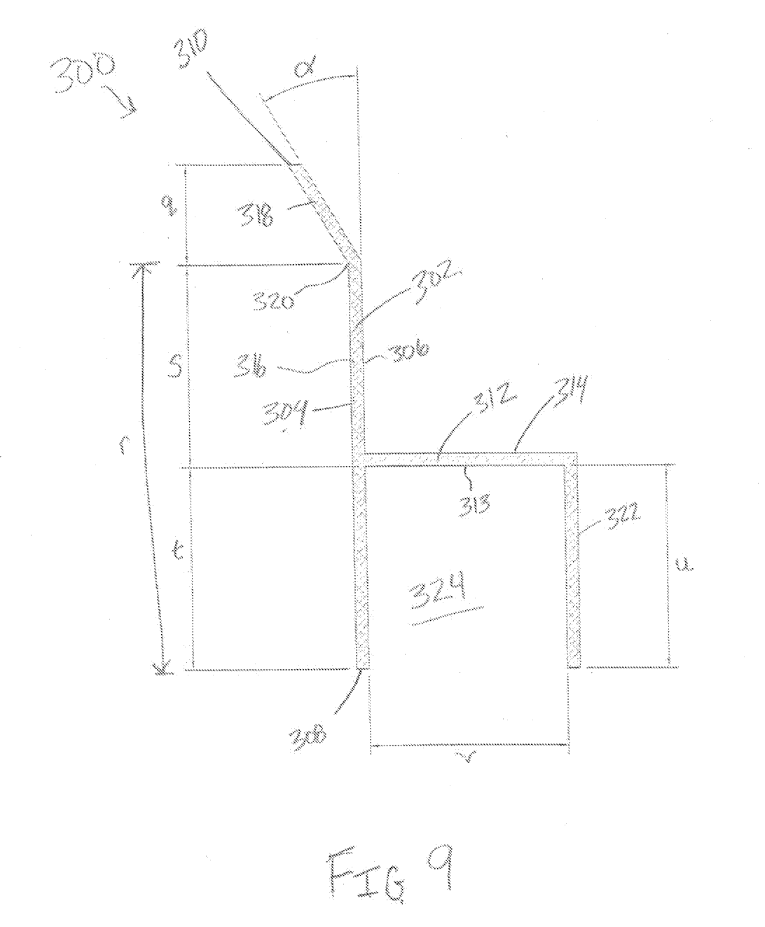

Referring now to FIG. 8, there is depicted a manhole assembly 200 incorporating guide members 100 according to an embodiment of the present disclosure. The manhole assembly 200 may comprise a base section 202, a riser section 204, a cone section 206, a ring section 208, a frame 210, and a cover 212. The base section 202 may have a riser portion 203 extending therefrom. The riser section 204 and the riser portion 203 may be tubular members. In an embodiment of the present disclosure, the base section 202, the riser section 204, and the cone section 206 may be formed from a polymer concrete.

A guide member 100 may be interposed between the riser portion 203 of the base section 202 and the riser section 204. Another guide member 100 may be interposed between the riser section 204 and the cone section 206. It will be appreciated that the use of the guide members 100 may eliminate the need for a tongue and groove joint between the riser section 203 and the riser portion 204, and the riser section 204 and the cone section 209 in the manhole assembly 200.

During installation of the manhole assembly 200, a hole may be excavated in the ground. The base section 202, with the riser portion 203, may be placed into the bottom of the hole using a lift, such as a crane. A guide member 100 may be installed onto a top portion of the riser portion 203 of the base section 202. The riser portion 204 may then be lifted over the riser portion 203 of the base section 202. The riser section 204 may then be lowered onto the riser portion 203. A sloped portion 118 of the guide member 100 may guide and center the riser portion 204 into place on the base section 202. A ring portion 116 of the guide member 100 may further guide and center the riser section 204 onto the base section 202.

Once the riser section 204 is installed, the cone portion 206 may then be installed as follows. First, a guide member 100 may be placed onto a top portion of the riser section 204. The cone section 206 may then be lifted over the riser section 204 and lowered into place. A sloped portion 118 of the guide member 100 may guide and center the cone section 206 into place on the riser section. A ring portion 116 of the guide member 100 may further guide and center the cone section 206 onto the riser section 204. As can be observed, the guide members 100 form joints between the different sections of the manhole assembly 200.

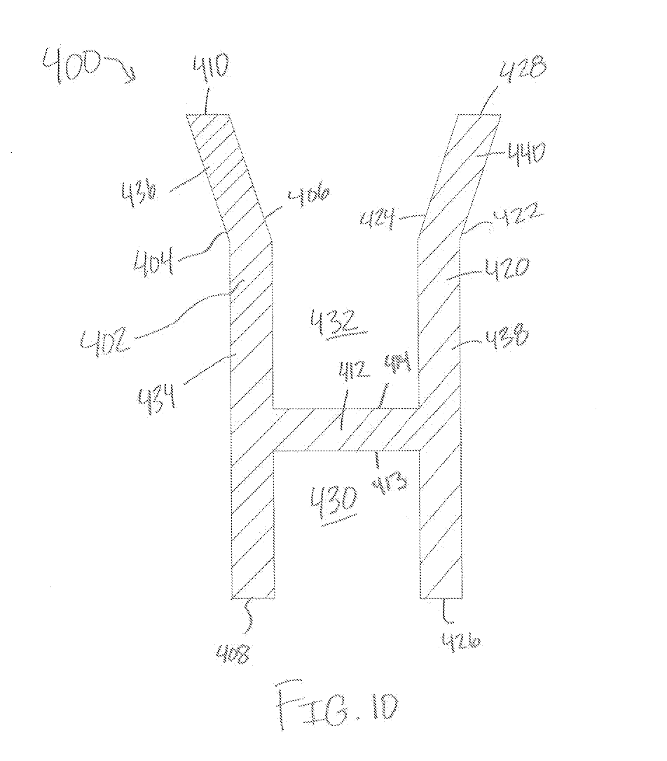

Referring now to FIG. 9, there is depicted a guide member 300 according to an embodiment of the present disclosure. The guide member 300 may take substantially the same annular shape of the guide member 100 shown in FIGS. 2-4. The guide member 300 may include a sidewall member 302 may have an outer surface 304 and an inner surface 306. A bottom surface 308 may extend between the outer surface 304 and the inner surface 306 to thereby form a lowermost portion of the guide member 300. A top surface 310 may extend between the outer surface 304 and the inner surface 306 to thereby form a topmost portion of the guide member 300. A cross-piece member 312 may extend inwardly from the inner surface 306 of the guide member 300. The cross-piece member 312 may include a bottom surface 313 and a top surface 314. The cross-piece member 312 may be perpendicular to the inner surface 306 of the guide member 300.

The sidewall member 302 may include a ring portion 316 and a sloped portion 318. The ring portion 316 may extend between the bottom surface 308 to a transition 320 between the ring portion 316 and the sloped portion 318. The sloped portion 318 may extend between the transition 320 and the top surface 310. The radiuses of the outer surface 304 and the inner surface 306 may be constant along the ring portion 316 of the sidewall member 302. The radiuses of the outer surface 304 and the inner surface 306 may increase along the sloped portion 318 of the sidewall member 302.

Extending downwardly from a terminal end of the cross-piece member 312 may be a leg member 322. The cross-piece member 312, the leg member 322 and the inner surface 306 of the sidewall member 302 may define a seat 324 for receiving a top portion of a tubular member. The guide member 300 may be utilized in the same manner as the guide member 100 as shown in FIGS. 6-8.

In an embodiment of the present disclosure, the ring portion 316 may have a height r of between about 3 inches to about 7 inches. In an embodiment of the present disclosure, the height r may be about 4 inches. The heights s and t as shown in FIG. 9 may be about 2 inches each. The sloped portion 318 may have a height q of about ½ inch to about 3 inches. The sloped portion 318 may have a height q of about 1 inch.

In an embodiment of the present disclosure, the cross-piece member 312 may have length v of about the same thickness of a wall of a tubular member onto which the guide member 300 is installed. In an embodiment of the present disclosure, the length v of the cross-piece member 312 may be about 1 to 3 inches, or about 2 inches. The leg 322 may have a height u of about 1 to 3 inches, or about 2 inches. The sloped portion 318 may be angled about 20 to 40 degrees, or about 30 degrees, from vertical as indicated.

Referring now to FIG. 10, there is depicted a guide member 400 according to an embodiment of the present disclosure. The guide member 400 may take substantially the same annular shape of the guide member 100 shown in FIGS. 2-4. The guide member 400 may include a first sidewall member 402 which may have an outer surface 404 and an inner surface 406. A bottom surface 408 may extend between the outer surface 404 and the inner surface 406 to thereby form a lowermost portion of the guide member 400. A top surface 410 may extend between the outer surface 404 and the inner surface 406 to thereby form a topmost portion of the guide member 400.

The guide member 400 may include a second sidewall member 420 having an outer surface 422 and an inner surface 424. A bottom surface 426 may extend between the outer surface 422 and the inner surface 426 to thereby form a lowermost portion of the guide member 400. A top surface 428 may extend between the outer surface 422 and the inner surface 424 to thereby form a topmost portion of the guide member 400.

A cross-piece member 412 may extend between the inner surface 406 and the inner surface 424. The cross-piece member 412 may include a bottom surface 413 and a top surface 414. The cross-piece member 412 may be perpendicular to the inner surface 406 and the inner surface 424. A seat 430 for receiving a top portion of a tubular member may be defined by the bottom surface 413 of the cross-piece member 412, the inner surface 406 and the inner surface 424. A seat 432 for receiving a bottom portion of a tubular member may be defined by the top surface 414 of the cross-piece member 412, the inner surface 406 and the inner surface 424.

The sidewall member 402 may comprise a ring portion 434 and a sloped portion 436. The sidewall member 420 may comprise a ring portion 438 and a sloped portion 440. It will be appreciated that the sloped portion 440 and the sloped portion 436 may facilitate insertion of a tubular member into the seat 432 by guiding and centering the tubular member into the seat 432. The guide member 400 may be utilized in the same manner as the guide member 100 as shown in FIGS. 6-8. In an embodiment of the present disclosure, the guide member 400 may be substantially H-shaped.

In an embodiment, a guide member according to the present disclosure may be annular or ring shaped to fit between adjacent tubular members. In an embodiment, a guide member according to the present disclosure may be arcuate to thereby engage a top wall of a tubular member, but not completely circumscribe the top wall. In this instance, multiple guide members may be utilized to form a joint between stacked tubular members. In an embodiment of the present disclosure, a joint sealant, such as cold tar, may be utilized in conjunction with the guide members. In an embodiment, a guide member according to the present disclosure may be formed from a resilient or flexible material, such as rubber. In an embodiment, a guide member according to the present disclosure may be formed from a flexible butyl mastic. A guide member according to the present disclosure may comply with ASTM C990.

In accordance with the features and combinations described above, an apparatus for forming a joint between a pair of tubular members may comprise:
a sidewall;
a crosspiece member extending from the sidewall; and
a sloped portion extending from a top of the sidewall.

In accordance with the features and combinations described above, a useful method of centering a first tubular member and a second tubular member includes the steps of:
(a) installing a guide member on an end of the first tubular member; and
(b) stacking the second tubular member on top of the first tubular member;
wherein the guide member comprises a sidewall, a crosspiece member extending from the sidewall, and a sloped or slanted portion extending from a top of the sidewall.

Those having ordinary skill in the relevant art will appreciate the advantages provide by the features of the present disclosure. For example, it is a feature of the present disclosure to provide an apparatus for facilitating the formation of a joint between a pair of tubular members. It is a feature of the present disclosure to provide a guide member for centering adjacent tubular members.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim.

Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. An apparatus for centering stacked tubular members, said apparatus comprising:
a first sidewall having a top portion and a bottom portion; and
a cross-piece member extending from the first sidewall;
wherein the top portion of the first sidewall extends above the cross-piece member and the bottom portion of the first sidewall extends below the cross-piece member;
wherein the top portion of the first sidewall includes a sloped portion.

2. The apparatus of claim 1, wherein the cross-piece member is cantilevered.

3. The apparatus of claim 1, further comprising a leg extending downwardly from the cross-piece member.

4. The apparatus of claim 3, wherein the leg, bottom portion of the sidewall and the cross-piece member define a seat for receiving a top portion of a tubular member.

5. The apparatus of claim 1, wherein the first sidewall is annular.

6. The apparatus of claim 1, wherein the first sidewall is arcuate.

7. The apparatus of claim 1, further comprising a second sidewall spaced apart from the first sidewall and having a top portion and a bottom portion, wherein the cross-piece member extends between the first sidewall and the second sidewall such that the top portion of the second sidewall extends above the cross-piece member and a bottom portion of the second sidewall extends below the cross-piece member.

8. The apparatus of claim 7, wherein the top portion of the second sidewall comprises a sloped portion.

9. The apparatus of claim 7, wherein the top portion of the first sidewall, the top portion of the second sidewall, and the cross-piece member define a seat for receiving an end of a tubular member.

10. The apparatus of claim 9, wherein the bottom portion of the first sidewall, the bottom portion of the second sidewall and the cross-piece member define a seat for receiving an end of a tubular member.

11. A method of connecting a first tubular member and a second tubular member, said method comprising:
providing a resilient guide member, said guide member comprising a first sidewall having a top portion and a bottom portion, and a cross-piece member extending from the first sidewall, wherein the top portion of the first sidewall extends above the cross-piece member and the bottom portion of the first sidewall extends below the cross-piece member, wherein the top portion of the first sidewall includes a sloped portion, wherein the bottom portion of the first sidewall and the cross-piece member define a first seat and the top portion of the first sidewall and the cross-piece member define a second seat;
installing the guide member onto an end of the first tubular member such that the first tubular member is installed into said first seat;
positioning the second tubular member in alignment with the first tubular member; and
installing an end the second tubular member into the second seat of the guide member such that the guide member centers the first and second tubular members with respect to each other.

12. The method of claim 11, wherein said first tubular member and said second tubular member are formed from polymer concrete.

13. The method of claim 12, wherein said first tubular member and said second tubular member have a wall thickness of about 2 inches.

14. The method of claim 11, wherein the cross-piece member is cantilevered.

15. The method of claim 11, further comprising a leg extending downwardly from the cross-piece member.

16. The method of claim 15, wherein the leg further defines the first seat.

17. The method of claim 11, wherein the first sidewall is annular.

18. The method of claim 11, wherein the first sidewall is arcuate.

19. The method of claim 11, further comprising a second sidewall spaced apart from the first sidewall and having a top portion and a bottom portion, wherein the cross-piece member extends between the first sidewall and the second sidewall such that the top portion of the second sidewall extends above the cross-piece member and a bottom portion of the second sidewall extends below the cross-piece member.

20. The method of claim 19, wherein the top portion of the second sidewall comprises a sloped portion.

21. A manhole assembly, said manhole assembly comprising:
a base section having an upwardly extending riser portion;
a riser section installed onto the riser portion of the base section; and
a resilient guide member interposed between the riser portion and the riser section;
wherein the guide member centers the riser portion and the riser section with respect to each other.

22. The manhole assembly of claim 21, wherein said riser section and said riser portion are formed from polymer concrete.

23. The manhole assembly of claim 22, wherein said riser section and said riser portion have a wall thickness of about 2 inches.

24. The manhole assembly of claim 21, wherein said guide member comprises a first sidewall having a top portion and a bottom portion, and a cross-piece member extending from the first sidewall, wherein the top portion of the first sidewall extends above the cross-piece member and the bottom portion of the first sidewall extends below the cross-piece member, wherein the bottom portion of the first sidewall and the cross-piece member define a first seat and the top portion of the first sidewall and the cross-piece member define a second seat, wherein the top portion of the first sidewall includes a sloped portion leading into the second seat;
wherein an end of the riser portion of the base section is installed into the first seat;
wherein an end of the riser section is installed into the second seat.

25. The manhole assembly of claim 24, wherein the cross-piece member is cantilevered.

26. The manhole assembly of claim 24, further comprising a leg extending downwardly from the cross-piece member and spaced apart from the bottom portion of the first sidewall.

27. The manhole assembly of claim 26, wherein the leg further defines the first seat.

28. The manhole assembly of claim 24, wherein the first sidewall is annular.

29. The manhole assembly of claim 24, wherein the first sidewall is arcuate.

30. The manhole assembly of claim 24, further comprising a second sidewall spaced apart from the first sidewall and having a top portion and a bottom portion, wherein the cross-piece member extends between the first sidewall and the second sidewall such that the top portion of the second sidewall extends above the cross-piece member and a bottom portion of the second sidewall extends below the cross-piece member.

31. The manhole assembly of claim 30, wherein the top portion of the second sidewall comprises a sloped portion.

32. The manhole assembly of claim 21, further comprising a cone section.

33. The manhole assembly of claim 32, further comprising a ring section and a manhole lid.

34. An apparatus for centering stacked tubular members, said apparatus comprising:
a first sidewall having a top portion and a bottom portion;
a cross-piece member extending from the first sidewall;
wherein the top portion of the first sidewall extends above the cross-piece member and the bottom portion of the first sidewall extends below the cross-piece member;
wherein the top portion of the first sidewall includes a sloped portion;
wherein the first sidewall is annular;
a second sidewall spaced apart from the first sidewall and having a top portion and a bottom portion;
wherein the cross-piece member extends between the first sidewall and the second sidewall such that the top portion of the second sidewall extends above the cross-piece member and a bottom portion of the second sidewall extends below the cross-piece member;
wherein the top portion of the second sidewall comprises a sloped portion;
wherein the top portion of the first sidewall, the top portion of the second sidewall, and the cross-piece member define an annular seat for receiving an end of a tubular member;
wherein the bottom portion of the first sidewall, the bottom portion of the second sidewall and the cross-piece member define an annular seat for receiving an end of a tubular member;
wherein the first sidewall, the second sidewall and the cross-piece member are formed from a resilient material.
